(19) United States
(12) Patent Application Publication
(10) Pub. No.: US 2026/0119925 A1
(43) Pub. Date: Apr. 30, 2026

(54) Dynamically Adjustable eXplainable Artificial Intelligence (XAI) Model

(71) Applicant: PayPal, Inc., San Jose, CA (US)

(72) Inventors: Boyu Tan, Shanghai (CN); Shupeng Geng, Shanghai (CN); Rong Liu, Shanghai (CN)

(21) Appl. No.: 18/950,364

(22) Filed: Nov. 18, 2024

(30) Foreign Application Priority Data
Oct. 25, 2024 (WO) PCT/CN2024/127237

(51) Int. Cl. G06N 5/045

(52) U.S. Cl. CPC G06N 5/045

(57) ABSTRACT

Techniques are disclosed for enhancing the transparency and interpretability of machine learning (ML) models using explainable artificial intelligence (XAI). In some embodiments, a computing system generates an XAI model that provides reasons for the outputs of a first ML model by selecting from a set of predefined reasons based on an aggregation function. This aggregation function combines importance scores for various features associated with the ML model's output, where each feature is mapped to a corresponding reason. The computing system may determine one or more parameters for the aggregation function to improve the accuracy of the selected reason, allowing for adjustments in how the aggregation function processes the importance scores. In certain cases, the system may involve an imitation model that is trained to replicate the first ML model's outputs.

### PRIORITY CLAIM

The present application claims priority to PCT Appl. No. PCT/CN2024/127237, entitled “DYNAMICALLY ADJUSTABLE EXPLAINABLE ARTIFICIAL INTELLIGENCE (XAI) MODEL,” filed Oct. 25, 2024, which is incorporated by reference herein in its entirety.

### BACKGROUND

### Technical Field

This disclosure relates generally to computer systems and, more specifically, to explainable artificial intelligence (XAI) models.

### Description of the Related Art

Machine learning (ML) algorithms have become increasingly popular across various industries due to their ability to analyze vast amounts of data and make accurate predictions or decisions without explicit programming. These algorithms are widely utilized in applications such as fraud detection, personalized marketing, customer segmentation, and predictive analytics. By learning from historical data, ML models can identify patterns and trends, allowing businesses to automate decision-making processes, enhance customer experiences, and optimize operational efficiency. However, the complexity of these models and their often opaque decision-making processes, commonly referred to as the “black-box” nature of ML, present challenges in understanding and explaining how specific outcomes are derived. As the reliance on ML models grows, so does the need for transparency and interpretability in their decision-making processes, especially in sensitive domains where trust and accountability are paramount.

### BRIEF DESCRIPTION OF THE DRAWINGS

FIG. 1 is a block diagram illustrating an explainable artificial intelligence (XAI) model system, according to some embodiments.

FIG. 2 is a block diagram illustrating an example system of adjudicating a conflict between two machine learning (ML) models, according to some embodiments.

FIG. 3 is a block diagram illustrating an example calculation of a top reason and score using an aggregation function, according to some embodiments.

FIG. 4 is a block diagram illustrating an example of imitation model training, according to some embodiments.

FIGS. 5A-B are flow diagrams illustrating embodiments of methods implementing techniques described herein.

FIG. 6 is a block diagram illustrating elements of an exemplary computer system for implementing techniques described herein.

### DETAILED DESCRIPTION

Machine learning (ML) models are tools that may be used across various domains due to their ability to process and analyze large datasets, which may lead to highly accurate predictions and decisions. However, in some examples, a limitation of these models is their inherent “black-box” nature, which may obscure the reasoning behind their outputs. In some cases, this lack of transparency may make it challenging for users to understand why a particular decision or prediction was made, which may be problematic in applications including, but not limited to, fraud detection, risk assessment, and customer authentication. In some aspects, there may be a need for mechanisms that can elucidate the relationship between input data and the resulting output of an ML model. By way of example, techniques such as a SHapley Additive explanations (SHAP) algorithm may provide a way to interpret the importance of different input features in driving a model's decision. However, while SHAP and similar methods offer insights into feature importance, they may fall short of explaining the broader reasoning behind a model's determinations. In some instances, there may be a need to develop models that can not only predict outcomes but also provide clear, understandable reasons for those outcomes, potentially enhancing transparency, trust, and accountability in ML-driven systems.

The present disclosure describes embodiments in which a computing system may integrate an explainable Artificial Intelligence (XAI) model, alongside an original machine learning (ML) model, that may provide transparent, interpretable reasons for the outputs generated by the ML model. In some embodiments, the computing system can receive a request to explain a particular output produced by the original ML model and/or an imitation model (e.g., trained to mimic the behavior of the original ML model). Upon receiving this request, a scoring algorithm (e.g., SHAP) may analyze the set of features that contributed to the ML model's output (e.g., a decision made by the ML model which may include a model score). These features, which may be derived from the input data processed by the ML model, may each be assigned an importance score (e.g., via the SHAP algorithm) that quantifies their influence on the final decision (or, said differently, is indicative of a given feature's impact on the original ML model's output). In some embodiments, these features may be mapped to a set of reasons and an aggregation function may combine the importance scores (e.g., for each feature mapped to a particular reason) to determine the most relevant reason for the model's output. In some examples, to ensure that the reason provided is as accurate and relevant as possible, the aggregation function may be fine-tuned using one or more parameters (referred to below as aggregation parameters) specifically designed to adjust how the importance scores are weighted and combined. In some instances, these parameters may be dynamically adjusted based on the context and specific requirements of the situation (e.g., for various use cases for the ML model), which may enhance the accuracy of the provided reasons and also improve the transparency and trustworthiness of the ML model.

In some embodiments, providing clear and understandable reasons for an output or decision of an ML model may improve user confidence, as users may be better able to comprehend the rationale behind the model's decisions. This transparency may lead to greater trust in ML models, such as in applications of fraud detection and risk management where understanding the basis for decisions may be of utmost importance.

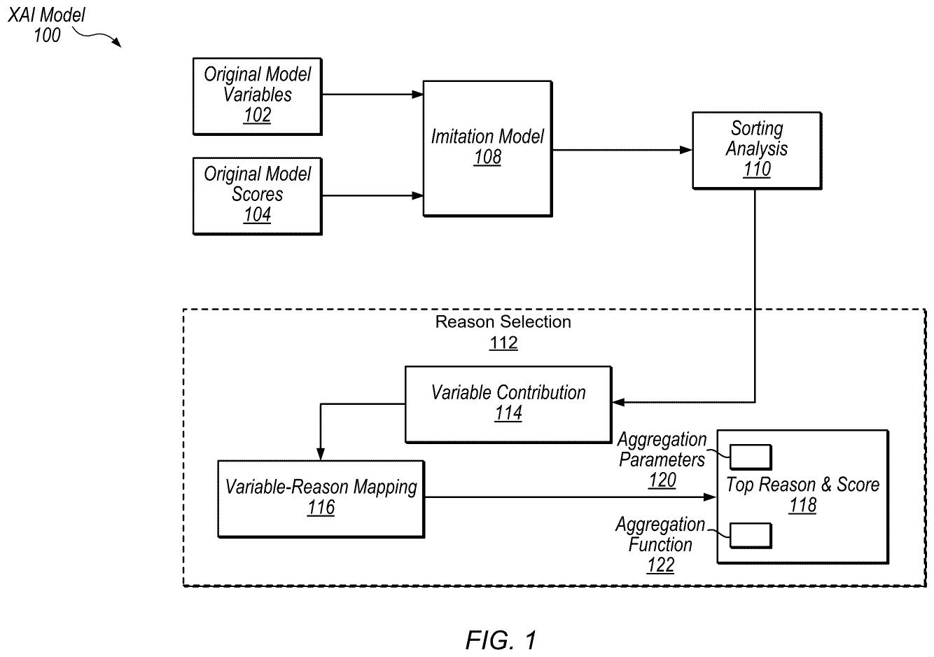

Turning now to FIG. 1, a block diagram of an XAI model 100 is depicted. In the illustrated embodiment of FIG. 1, XAI model 100 includes imitation model 108, which may receive original model variables/features 102 and/or original model scores 104 as inputs. In some aspects, imitation model 108 may output a signal (e.g., a score) to sorting analysis 110, which may apply a scoring algorithm such as a SHAP algorithm or similar method known to those skilled in the art to determine the importance of original model variables 102.

For instance, the importance of each variable within original model variables 102 may be assessed in terms of its influence/impact on the output generated by imitation model 108. As such, the importance of each variable may indicate how much that particular variable impacted the output, with an importance score calculated using the SHAP algorithm, directly proportional to the influence or weight of that variable in the final output. The output of sorting analysis 110 may be used by one or more components within reason selection 112 to determine one or more reasons (e.g., via top reason and score 118) explaining why imitation model 108 determined its respective output or score. In some embodiments, one or more components as illustrated within XAI model 100 in FIG. 1 may be implemented differently from what is shown (e.g., one or more components may be external to XAI model 100). For example, instead of imitation model 108, in some embodiments, the original ML model (not illustrated in FIG. 1) may be used.

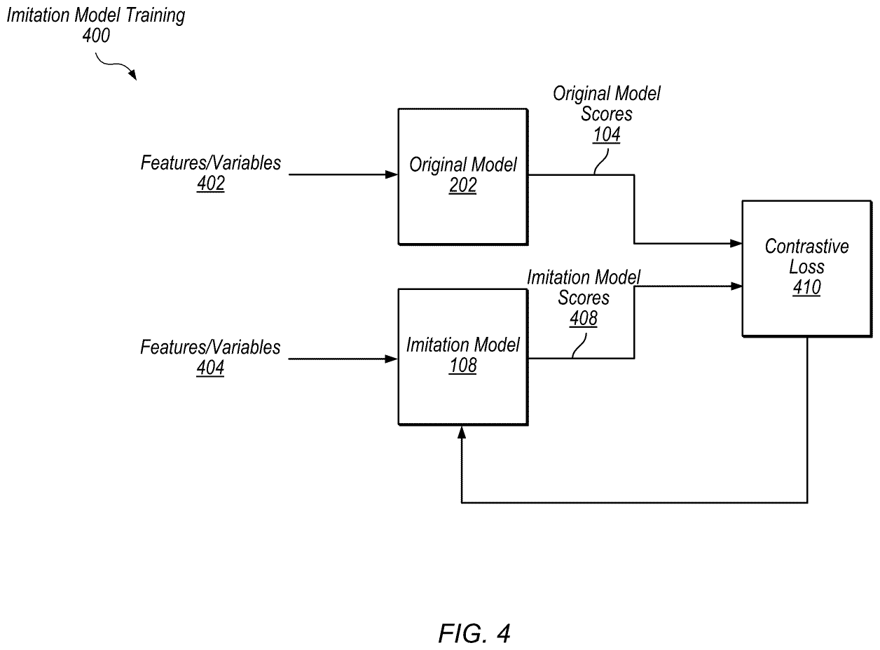

In some embodiments, imitation model 108 may be trained to imitate the original ML model by outputting the same results as the original ML model for the same input (e.g., original model variables 102). For example, given the same original model variables 102 as inputs, imitation model 108 may output the same score (e.g., a numerical value, where the numerical value relates to a recommended action) as the original ML model. In some aspects, imitation model 108 may be computationally less expensive than the original ML model and consequently produce outputs more quickly. In some embodiments, imitation model 108 may be trained via original model scores 104, as will be discussed in further detail with respect to FIG. 4.

In some examples, imitation model 108 may be used in the payment industry as a risk management tool to protect users and/or customers from fraudulent activity. In some aspects, beyond the payment industry, imitation model 108 can also be adapted for use in various other industries where it may serve as a decision-making tool to assess risk, predict outcomes, or optimize processes based on the analysis of key variables. Examples of industries that may employ imitation model 108 may include, but are not limited to, finance, healthcare, e-commerce, or telecommunications.

Consider an example of a use case for imitation model 108 in the finance industry for detecting fraud. In this example, imitation model 108 may receive original model variables 102 including, but not limited to, the user's typical IP address, the current IP address of the transaction, device information, geolocation data, transaction history, and other relevant profile details. If a user who typically conducts transactions from Southern California suddenly initiates a transaction from an IP address in Canada, imitation model 108 may output a score lower than a pre-defined threshold (e.g., where the pre-defined threshold differentiates between recommending one action versus another alternative action). This score may suggest a recommended action to deny the transaction due to the unusual activity (e.g., if imitation model 108 outputs a score below the pre-defined threshold it may suggest to deny the transaction but above the threshold may suggest to allow the transaction). Sorting analysis 110, which may include scoring algorithms such as SHAP, can then analyze the contribution of each variable within original model variables 102 to understand the factors influencing the output score, such as the discrepancy in IP addresses.

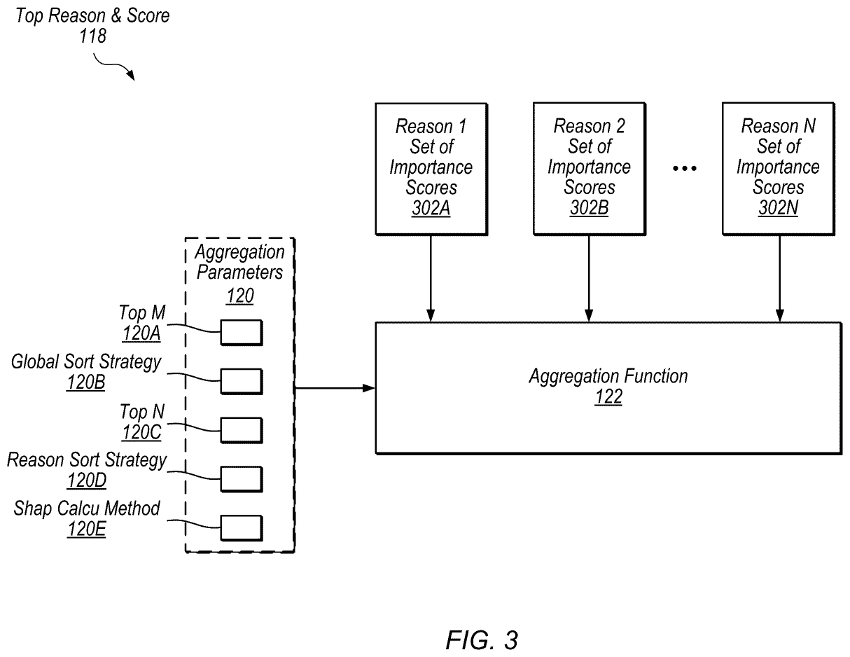

In some embodiments, the output of sorting analysis 110 may be input to reason selection 112. In some examples, reason selection 112 may include one or more components such as variable contribution 114, variable-reason mapping 116, and top reason and score 118. In some aspects, variable contribution 114 block may receive the output from sorting analysis 110, which may provide an importance score for each variable (also feature) within original model variables 102, indicating how much each variable contributed to the output produced by imitation model 108. In some embodiments, these importance scores are then passed to the variable-reason mapping 116, where each variable is mapped to one or more possible reasons for why imitation model 108 produced its respective output. In some cases, this mapping process can be thought of as assigning variables/features to “reason buckets,” where each reason bucket contains one or more variables along with their respective importance scores. Finally, the output of variable-reason mapping 116 is input to the top reason and score 118 block, which includes an aggregation function 122 and corresponding aggregation parameters 120. In some embodiments, aggregation function 122 combines the importance scores of all the variables within each reason bucket and calculates a score for each reason (e.g., this may be referred to as an aggregated importance score for a particular reason). Based on these scores, the system may output the top reason (e.g., the reason bucket with the highest combined importance score or aggregated importance score) or multiple top reasons (e.g., the top 3 reason buckets, top 2 reason buckets, etc.). In some embodiments, top reason & score 118 may also output one or more scores such as the sum or average of the importance scores (e.g., sum or average may be configurable via SHAP calcu method, which will be discussed in further detail in FIG. 3) for the variables mapped to the top reasons. In some aspects, aggregation parameters 120 may be configured to adjust how the aggregation function 122 calculates the score for each reason bucket, influencing the final selection of one or more reasons output by top reason and score 118. This process will be described in further detail with respect to FIG. 3.

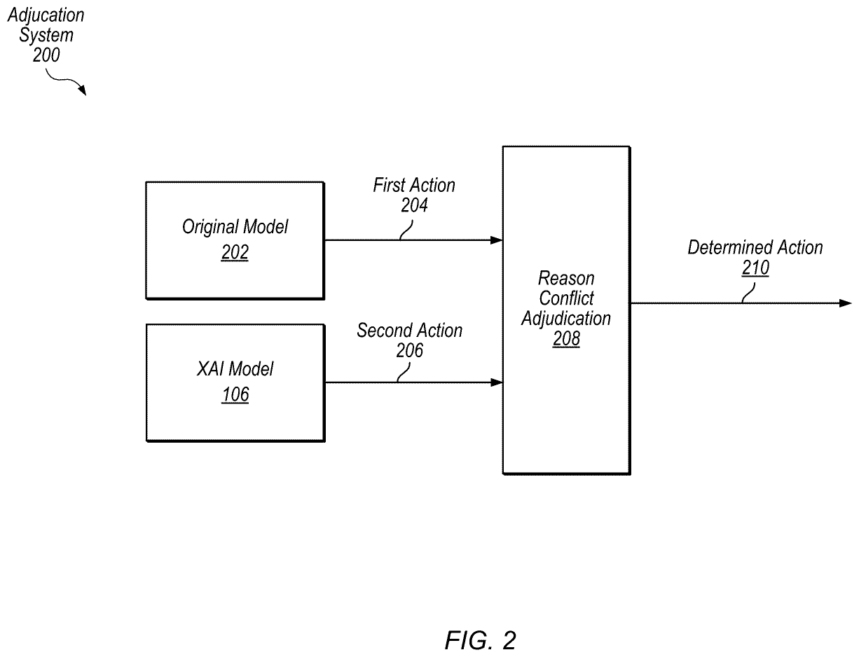

Turning now to FIG. 2, a block diagram illustrating an example system 200 of adjudicating a conflict between two machine learning (ML) models is depicted. In the illustrated embodiment of FIG. 2, original ML model 202 and XAI model 106 generate outputs, referred to as first action 204 and second action 206, respectively. Consider a scenario where original model 202 recommends a first action 204 (e.g., based on original model scores 104), such as denying a transaction due to the original model scores falling below a pre-determined threshold as discussed above with respect to FIG. 1. XAI model 106 may, however, output a top reason recommending a second action 206 that suggests the transaction should be allowed based on the identified top reason.

In this example and in some embodiments, reason conflict adjudication 208 serves as a decision-making module that determines whether a conflict exists between the first action 204 recommended by original model 202 and the second action 206 recommended by XAI model 106. If a conflict is detected, reason conflict adjudication 208 may override the first action 204 proposed by original model 202 and adopt the second action 206 from XAI model 106, resulting in a determined action 210 that reflects the output of the XAI model 106. For instance, in this example, determined action 210 may override first action 204, which denied the transaction with second action 206 to allow the transaction. Conversely, reason conflict adjudication 208 may also determine that a conflict does not warrant an override, in which case, in this example determined action 210 may align with the original model's first action 204 to deny the transaction. In some aspects, this adjudication process allows system 200 to reconcile differences between the decisions of original ML model 202 (e.g., based on original ML model scores 104) and the XAI model (e.g., based on the output of top reason and score 118), ensuring that the most appropriate action is taken based on the combined analysis of both models.

Turning now to FIG. 3, a block diagram illustrating an example calculation of a top reason and score 118 using aggregation function 122 is shown. In the illustrated embodiment, a set of reasons 302A, 302B through 302N representing N number of reasons each include one or more variables/features (e.g., from original model variables 102) mapped to it, respectively. In some aspects, each variable has a respective importance score (e.g., calculated via sorting analysis 110 and/or variable contribution 114). As such, each reason 302 may include a set of one or more importance scores corresponding to the one or more variables mapped to it.

In some embodiments, aggregation function 122 aggregates or combines the set of importance scores for each reason 302 to determine a respective aggregated importance score for each reason 302. In some aspects, as discussed above, the reason 302 with the largest aggregated importance score may be selected as the top reason output by top reason and score 118. In some cases, one or more reasons may be output by top reason and score 118 (e.g., one or more reasons with aggregated importance scores above a pre-determined threshold, or a selected number of reasons of the highest aggregated importance scores). In some embodiments, aggregation function 122 may include one or more aggregation parameters 120 that influence or affect how aggregation function 122 calculates or determines an aggregated importance score. In some risk management system, XAI model can be used to correct the judgement of original model, aggregation function 122 may be as depicted as the following example equation:

$${max}_{m , n , f} \sum {Vol ( dc ln )}_{{rc}_{j}} \times I [ {FPR ( dc ln )}_{{rc}_{j}} \geq 63 ] + {Vol ( cmpl )}_{{rc}_{j}} \times {Gbps ( cmpl )}_{{rc}_{j}} \times I [ {Gbps ( cmpl )}_{{rc}_{j}} \geq 700 ]$$

$$Where {shap}_{{rc}_{j}} = f ( {shap}_{{var}_{i}} \vert top m variables and top n in {rc}_{j} )$$

In the example equation, dcln is short for declined (e.g., declined transaction population), cmpl for completed (e.g., loss savings from originally completed transactions), rc for Top1 reason code, Vol for volume (e.g., transaction volume where Vol(dcln)rcⱼ represents the total declined transaction amount under reason code j), FPR is false positive rate, and Gbps is gross loss bps, which relates to the risk of a particular reason code with high Gbps corresponding high risky population. This optimization function can be broken into two terms by adding them up. The first term is related to use XAI model to do the TPV enablement by free the high FPR population that was declined by the original risk model. The second term is related to further decline by XAI model for loss saving from the population that was approved.

In some embodiments, aggregation parameters 120 may include, but are not limited to, top M 120A, global sort strategy 120B, top N 120C, reason sort strategy 120D, and/or SHAP calcu method 120E. In some aspects, aggregation parameters 120 may be configured to adjust the output of aggregation function 122 such as optimizing the accuracy of the reason selected. By way of example, determining aggregation parameters 120 may include calculating a cost function. In some aspects, the cost function may be associated with a false positive rate (FPR), where the FPR defines a rate of incorrectly determining whether to perform an action based on a determined or selected reason (e.g., which is calculated via aggregation function 122 and corresponding aggregation parameters 120). For example, top reason and score 118 may select, based on aggregation function 122 and aggregation parameters 120, a top reason corresponding to an action (e.g., second action 206) for incorrectly denying a transaction when the transaction should have been allowed. As such, this example may contribute to a false positive rate and cost function. In some embodiments, aggregation parameters 120 may be configured or determined (e.g., via computing system 600) automatically to optimize the cost function (e.g., minimizing the risk of false positives or reducing the FPR).

In some aspects, top M 120A may represent the number of variables/features (e.g., within original model variables 102) that are considered by XAI model 100. For instance, in the use case as discussed above with respect to FIG. 1 for detecting fraud, consider that original model variables 102 may include 200 total variables. In this example, top M 120A may be set as 100, which may indicate that only the top 100 variables as determined by sorting analysis 110 (e.g., the SHAP algorithm) may be considered (e.g., the top 100 based on the variables' importance scores as determined by the SHAP algorithm). As such, in this example only the top M 120 number of variables are used for the reason calculation (e.g., via reason selection 112, top reason and score 118). In some examples, global sort strategy 120B may indicate to use either the absolute or original SHAP value to get the highest top M 120A variables.

In some embodiments, top N 120C may represent the number of variables/features that are considered for each reason “bucket” 302. For example, consider reason 1 302A includes a set of importance scores for 50 variables/features mapped to it. In this example, top N 120C may indicate that only the top N 120C (e.g., where N is an integer) number of variables may be used by aggregation function 122. As such, if N is set to 20, aggregation function 122 may aggregate the importance scores for only the top 20 of the 50 number of variables mapped to reason 1 302A. In some embodiments, each reason 302 (e.g., reason 1 302A, reason 2 302B, reason N 302N, etc.) may have their own respective top N 120C value. In some embodiments, top N 120C may be set to a pre-determined threshold, such that only the variables/features within each reason 302 with importance scores above the pre-determined threshold are used by aggregation function 122. In some examples, reason sort strategy 120D may indicate to use the absolute or original SHAP value to get the highest top N 120C value.

In some embodiments, after top M 120A/global sort strategy 120B, top N 120C/reason sort strategy 120D of aggregation parameters 120 are decided, the variables/features participating in the calculation of aggregation function 122 for each reason 302 may be determined (e.g., via variable-reason mapping 116). The SHAP calcu method 120E parameter may be configured to indicate whether to calculate the sum or average of all the importance scores for all the variables mapped to each reason 302. Accordingly, the top reason may be determined as the reason “bucket” 302 (e.g., reason 1 302A, reason 2 302B, etc.) with either the highest average or sum of importance scores for the variables mapped to that respective reason 302 (i.e., this may be toggled via SHAP calcu method 120E).

Turning now to FIG. 4, a block diagram illustrating an example of imitation model training 400 is depicted. In the illustrated embodiment, imitation model 108 is trained to output imitation model scores 408 that are equivalent to original model scores 104, which are output from original ML model 202.

In this training process, in some embodiments, the goal is to align the output of imitation model 108 with that of original ML model 202. Specifically, both the original model scores 104 and the imitation model scores 408 may be input into contrastive loss 410, which may calculate the deviation or difference between these two sets of scores. In some instances, this difference may act as a feedback signal that is used to adjust the parameters of imitation model 108. Over successive iterations, this feedback loop may gradually reduce the deviation, causing imitation model scores 408 to converge towards or become equivalent to original model scores 104. In some aspects, once this training process is complete and the outputs are sufficiently aligned, the trained imitation model 108 may effectively replicate the behavior of original ML model 202. In some embodiments, the features/variables 402 provided to original model 202 are identical to the features/variables 404 input to imitation model 108. Therefore, for the same inputs, both original model 202 and imitation model 108 may produce the same outputs, original model scores 104 and imitation model scores 408, respectively.

In some embodiments, both original ML model 202 and imitation model 108 may be implemented as machine learning models, which may include various types of neural networks. Neural networks are a class of models that consist of interconnected layers of nodes or “neurons,” which process input data and generate outputs through weighted connections. These weights are adjusted during training to minimize the error between the predicted output and the actual output. For example, original ML model 202 and imitation model 108 may be implemented as deep neural networks (DNNs), convolutional neural networks (CNNs) for image data, recurrent neural networks (RNNs) for sequential data, or other types of architectures depending on the specific application. Those skilled in the art will appreciate additional types of neural networks that may be used to implement original ML model 202 and/or imitation model 108. These models may be trained on large datasets and capable of learning complex patterns and making predictions with high accuracy. In the context of FIG. 4, the neural networks may be trained such that imitation model 108 effectively learns to mimic the outputs of the original ML model 202 such that both models produce consistent results for the same input data.

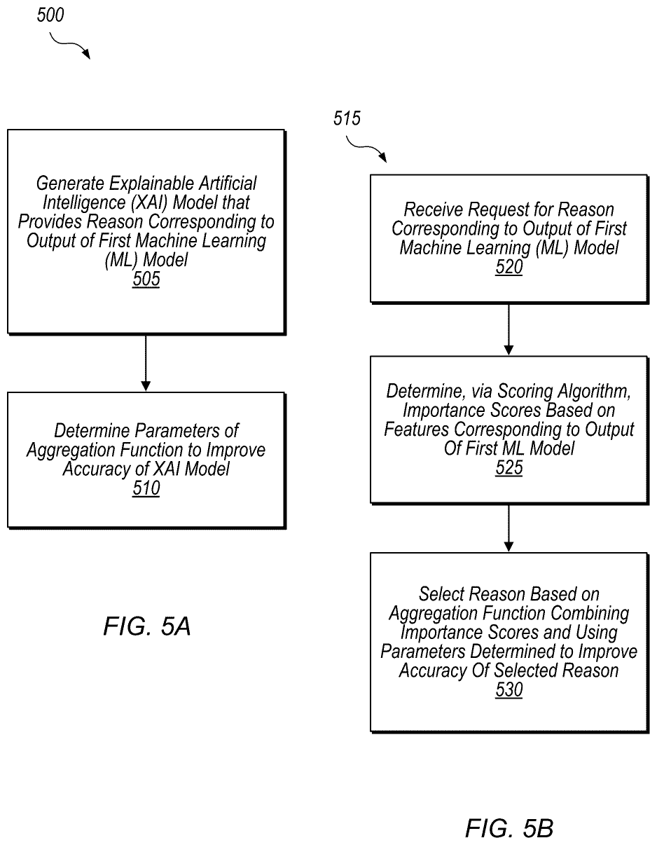

Turning now to FIG. 5A, a flow diagram of a method 500 is shown. Method 500 is one embodiment of a method performed by a computing system 600. Method 500 may be performed by executing a set of program instructions stored on a non-transitory computer-readable medium.

Method 500 begins in step 505 with the computing system generating an explainable artificial intelligence (XAI) model. In various embodiments, the XAI model provides a reason corresponding to an output of a first machine learning (ML) model. The XAI model selects the reason from a set of reasons based on an aggregation function. The aggregation function combines a set of importance scores for a corresponding set of features mapped to the reason. For example, XAI model 100 may output one or more reasons and/or one or more scores corresponding to the output of a first ML model, such as original ML model 202. In some cases, XAI model 100 may map variables/features 102 that are input to original ML model 202 to corresponding reasons 302.

In step 510, the computing system determines one or more parameters of the aggregation function to improve the accuracy of the reason selected from the set of reasons, the one or more parameters being operable to adjust the output of the aggregation function. For example, the computing system may calculate aggregation parameters 120 to optimize aggregation function 122. In some cases, this may include calculating a cost function where the cost function determines a false positive rate, and aggregation parameters 120 are determined in order to minimize the false positive rate.

In various embodiments, method 500 further includes the computing system training an imitation model based on inputs and outputs of the first ML model such that the imitation model is trained to imitate the first ML model. In various embodiments, the imitation model is computationally less expensive than the first ML model. The XAI model selects the reason based on an imitation output of the imitation model. For example, imitation model 108 may be trained (e.g., as illustrated in FIG. 4) such that the output imitates or matches the output of original ML model 202. In some examples, the output (e.g., score) of imitation model 108 may be used XAI model 100 to determine the one or more top reasons and/or scores (e.g., via top reason and score 118).

In some embodiments, method 500 further includes the computing system determining, via a scoring algorithm, the set of importance scores based on the corresponding set of features, wherein the set of features correspond to the output of the first ML model. For example, sorting analysis 110 may use a scoring algorithm, such as a SHAP algorithm, a set of importance scores for each of the features (original model variables 102) from original ML model 202. In some embodiments, the SHAP algorithm outputs the set of importance scores for the corresponding set of features, wherein the one or more parameters includes a parameter (e.g., top M 120A) that causes the aggregation function to select a subset of the importance scores. For example, top M 120A may indicate the number of variables within original model variables 102 that are considered by reason selection 112 (e.g., and aggregation function 122). As such, top M 120A may indicate the number of variables to be used by reason selection 112 based on the variable's importance scores as determined by the SHAP algorithm (e.g., the top M 120A number of variables within original model variables 102 as ranked by their respective importance scores).

In some embodiments, the aggregation function determines a reason score for a given reason within the set of reasons by combining relevant importance scores mapped to the given reason, wherein the one or more parameters include a parameter (e.g., top N 120C) that defines the number of combined relevant importance scores. For example, top N 120C may indicate the number of variables and their respective importance scores that are considered by each reason 302.

In some embodiments, method 500 further includes the computing system receiving, the output of the first ML model, where the output recommends a first action (e.g., first action 204). Method 500 further includes determining, whether to perform the first action based on the selected reason. For example, the computing system (e.g., reason conflict adjudication 208) may make a determination whether to perform first action 204 based on the reason (e.g., top reason) as determined by top reason and score 118. In some embodiments, method 500 further includes identifying a conflict between the selected reason (e.g., a top reason as determined by top reason and score 118) and the recommended first action (e.g., first action 204) and determining, based on the identified conflict, to not perform the first action. For example, first action 204 from original model 202 may recommend to deny a transaction while second action 206, based on the top reason as determined by XAI model 106 may recommend to allow the transaction. In this example, a conflict exists and reason conflict adjudication 208 may determine to not deny the transaction (e.g., not perform the first action 204) and accordingly allow the transaction as recommended by second action 206.

Turning now to FIG. 5B, a flow diagram of a method 515 is shown. Method 515 is one embodiment of a method performed by a computing system (e.g., computing system 600) and may be performed by executing a set of program instructions stored on a non-transitory computer-readable medium.

Method 515 begins in step 520 with the computing system (e.g., computing system 600) receiving a request for a reason corresponding to an output of a first machine learning (ML) model (e.g., original ML model 202). In step 525, the computing system determines, via a scoring algorithm (e.g., via sorting analysis 110), a set of importance scores based on a corresponding set of features input into the first ML model (e.g., original ML model 202) such that a given one of the importance scores is indicative of a given feature's impact on the received output. For example, sorting analysis 110 may use a SHAP algorithm to determine a set of importance scores for the variables within original model variables 102 indicating their respective contributions to the output of first ML model. In some aspects, the output of imitation model 108 (e.g., after training) may be the same as the output of first ML model (e.g., original ML model 202).

In step 530, the computing system selects the reason (e.g., the top reason from top reason and score 118) from a set of reasons (e.g., reasons 302) based on an aggregation function (e.g., aggregation function 122) applied to the importance scores, wherein the aggregation function combines the set of importance scores for the corresponding set of features based on one or more parameters (e.g., aggregation parameters 120) determined to improve the accuracy of the XAI model, wherein the one or more parameters are operable to adjust the output of the aggregation function.

### Exemplary Computer System

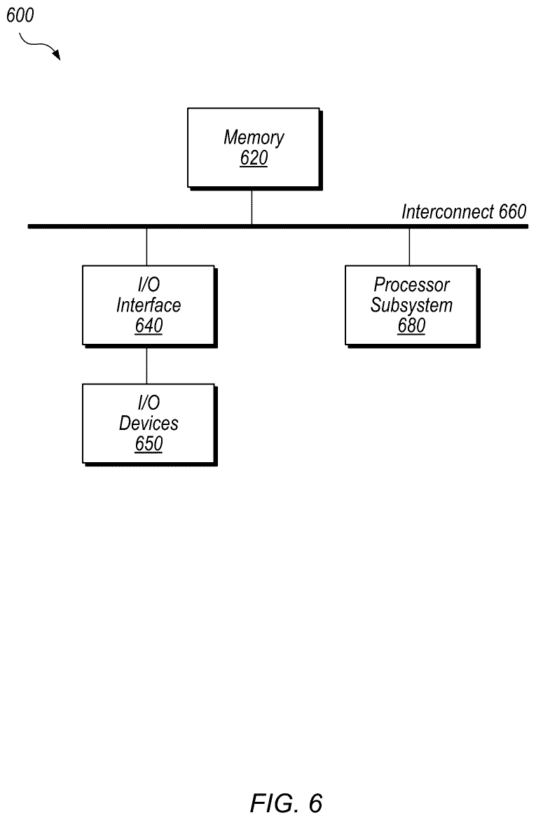

Turning now to FIG. 6, a block diagram of an exemplary computer system 600, which may implement XAI model system 100 (or one or more components included in XAI model system 100), is depicted. Computer system 600 includes a processor subsystem 680 that is coupled to a system memory 620 and I/O interfaces(s) 640 via an interconnect 660 (e.g., a system bus). I/O interface(s) 640 is coupled to one or more I/O devices 650. Although a single computer system 600 is shown in FIG. 6 for convenience, system 600 may also be implemented as two or more computer systems operating together.

Processor subsystem 680 may include one or more processors or processing units. In various embodiments of computer system 600, multiple instances of processor subsystem 680 may be coupled to interconnect 660. In various embodiments, processor subsystem 680 (or each processor unit within 680) may contain a cache or other form of on-board memory.

System memory 620 is usable store program instructions executable by processor subsystem 680 to cause system 600 perform various operations described herein. System memory 620 may be implemented using different physical memory media, such as hard disk storage, floppy disk storage, removable disk storage, flash memory, random access memory (RAM-SRAM, EDO RAM, SDRAM, DDR SDRAM, RAMBUS RAM, etc.), read only memory (PROM, EEPROM, etc.), and so on. Memory in computer system 600 is not limited to primary storage such as memory 620. Rather, computer system 600 may also include other forms of storage such as cache memory in processor subsystem 680 and secondary storage on I/O Devices 650 (e.g., a hard drive, storage array, etc.). In some embodiments, these other forms of storage may also store program instructions executable by processor subsystem 680. In some embodiments, program instructions that when executed implement elements of XAI model system 100 (e.g., elements 130, 140, 170, 420, 430, etc.) may be included/stored within system memory 620.

I/O interfaces 640 may be any of various types of interfaces configured to couple to and communicate with other devices, according to various embodiments. In one embodiment, I/O interface 640 is a bridge chip (e.g., Southbridge) from a front-side to one or more back-side buses. I/O interfaces 640 may be coupled to one or more I/O devices 650 via one or more corresponding buses or other interfaces. Examples of I/O devices 650 include storage devices (hard drive, optical drive, removable flash drive, storage array, SAN, or their associated controller), network interface devices (e.g., to a local or wide-area network), or other devices (e.g., graphics, user interface devices, etc.). In one embodiment, computer system 600 is coupled to a network via a network interface device 650 (e.g., configured to communicate over Wi-Fi®, Bluetooth®, Ethernet, etc.).

The present disclosure includes references to “embodiments,” which are non-limiting implementations of the disclosed concepts. References to “an embodiment,” “one embodiment,” “a particular embodiment,” “some embodiments,” “various embodiments,” and the like do not necessarily refer to the same embodiment. A large number of possible embodiments are contemplated, including specific embodiments described in detail, as well as modifications or alternatives that fall within the spirit or scope of the disclosure. Not all embodiments will necessarily manifest any or all of the potential advantages described herein.

This disclosure may discuss potential advantages that may arise from the disclosed embodiments. Not all implementations of these embodiments will necessarily manifest any or all of the potential advantages. Whether an advantage is realized for a particular implementation depends on many factors, some of which are outside the scope of this disclosure. In fact, there are a number of reasons why an implementation that falls within the scope of the claims might not exhibit some or all of any disclosed advantages. For example, a particular implementation might include other circuitry outside the scope of the disclosure that, in conjunction with one of the disclosed embodiments, negates or diminishes one or more the disclosed advantages. Furthermore, suboptimal design execution of a particular implementation (e.g., implementation techniques or tools) could also negate or diminish disclosed advantages. Even assuming a skilled implementation, realization of advantages may still depend upon other factors such as the environmental circumstances in which the implementation is deployed. For example, inputs supplied to a particular implementation may prevent one or more problems addressed in this disclosure from arising on a particular occasion, with the result that the benefit of its solution may not be realized. Given the existence of possible factors external to this disclosure, it is expressly intended that any potential advantages described herein are not to be construed as claim limitations that must be met to demonstrate infringement. Rather, identification of such potential advantages is intended to illustrate the type(s) of improvement available to designers having the benefit of this disclosure. That such advantages are described permissively (e.g., stating that a particular advantage “may arise”) is not intended to convey doubt about whether such advantages can in fact be realized, but rather to recognize the technical reality that realization of such advantages often depends on additional factors.

Unless stated otherwise, embodiments are non-limiting. That is, the disclosed embodiments are not intended to limit the scope of claims that are drafted based on this disclosure, even where only a single example is described with respect to a particular feature. The disclosed embodiments are intended to be illustrative rather than restrictive, absent any statements in the disclosure to the contrary. The application is thus intended to permit claims covering disclosed embodiments, as well as such alternatives, modifications, and equivalents that would be apparent to a person skilled in the art having the benefit of this disclosure.

For example, features in this application may be combined in any suitable manner. Accordingly, new claims may be formulated during prosecution of this application (or an application claiming priority thereto) to any such combination of features. In particular, with reference to the appended claims, features from dependent claims may be combined with those of other dependent claims where appropriate, including claims that depend from other independent claims. Similarly, features from respective independent claims may be combined where appropriate.

Accordingly, while the appended dependent claims may be drafted such that each depends on a single other claim, additional dependencies are also contemplated. Any combinations of features in the dependent that are consistent with this disclosure are contemplated and may be claimed in this or another application. In short, combinations are not limited to those specifically enumerated in the appended claims.

Where appropriate, it is also contemplated that claims drafted in one format or statutory type (e.g., apparatus) are intended to support corresponding claims of another format or statutory type (e.g., method).

Because this disclosure is a legal document, various terms and phrases may be subject to administrative and judicial interpretation. Public notice is hereby given that the following paragraphs, as well as definitions provided throughout the disclosure, are to be used in determining how to interpret claims that are drafted based on this disclosure.

References to a singular form of an item (i.e., a noun or noun phrase preceded by “a,” “an,” or “the”) are, unless context clearly dictates otherwise, intended to mean “one or more.” Reference to “an item” in a claim thus does not, without accompanying context, preclude additional instances of the item. A “plurality” of items refers to a set of two or more of the items.

The word “may” is used herein in a permissive sense (i.e., having the potential to, being able to) and not in a mandatory sense (i.e., must).

The terms “comprising” and “including,” and forms thereof, are open-ended and mean “including, but not limited to.”

When the term “or” is used in this disclosure with respect to a list of options, it will generally be understood to be used in the inclusive sense unless the context provides otherwise. Thus, a recitation of “x or y” is equivalent to “x or y, or both,” and thus covers 1) x but not y, 2) y but not x, and 3) both x and y. On the other hand, a phrase such as “either x or y, but not both” makes clear that “or” is being used in the exclusive sense.

A recitation of “w, x, y, or z, or any combination thereof” or “at least one of . . . w, x, y, and z” is intended to cover all possibilities involving a single element up to the total number of elements in the set. For example, given the set [w, x, y, z], these phrasings cover any single element of the set (e.g., w but not x, y, or z), any two elements (e.g., w and x, but not y or z), any three elements (e.g., w, x, and y, but not z), and all four elements. The phrase “at least one of . . . w, x, y, and z” thus refers to at least one element of the set [w, x, y, z], thereby covering all possible combinations in this list of elements. This phrase is not to be interpreted to require that there is at least one instance of w, at least one instance of x, at least one instance of y, and at least one instance of z.

Various “labels” may precede nouns or noun phrases in this disclosure. Unless context provides otherwise, different labels used for a feature (e.g., “first circuit,” “second circuit,” “particular circuit,” “given circuit,” etc.) refer to different instances of the feature. Additionally, the labels “first,” “second,” and “third” when applied to a feature do not imply any type of ordering (e.g., spatial, temporal, logical, etc.), unless stated otherwise.

The phrase “based on” or is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

The phrases “in response to” and “responsive to” describe one or more factors that trigger an effect. This phrase does not foreclose the possibility that additional factors may affect or otherwise trigger the effect, either jointly with the specified factors or independent from the specified factors. That is, an effect may be solely in response to those factors, or may be in response to the specified factors as well as other, unspecified factors. Consider the phrase “perform A in response to B.” This phrase specifies that B is a factor that triggers the performance of A, or that triggers a particular result for A. This phrase does not foreclose that performing A may also be in response to some other factor, such as C. This phrase also does not foreclose that performing A may be jointly in response to B and C. This phrase is also intended to cover an embodiment in which A is performed solely in response to B. As used herein, the phrase “responsive to” is synonymous with the phrase “responsive at least in part to.” Similarly, the phrase “in response to” is synonymous with the phrase “at least in part in response to.”

Within this disclosure, different entities (which may variously be referred to as “units,” “circuits,” other components, etc.) may be described or claimed as “configured” to perform one or more tasks or operations. This formulation-[entity] configured to [perform one or more tasks]—is used herein to refer to structure (i.e., something physical). More specifically, this formulation is used to indicate that this structure is arranged to perform the one or more tasks during operation. A structure can be said to be “configured to” perform some task even if the structure is not currently being operated. Thus, an entity described or recited as being “configured to” perform some task refers to something physical, such as a device, circuit, a system having a processor unit and a memory storing program instructions executable to implement the task, etc. This phrase is not used herein to refer to something intangible.

In some cases, various units/circuits/components may be described herein as performing a set of task or operations. It is understood that those entities are “configured to” perform those tasks/operations, even if not specifically noted.

The term “configured to” is not intended to mean “configurable to.” An unprogrammed FPGA, for example, would not be considered to be “configured to” perform a particular function. This unprogrammed FPGA may be “configurable to” perform that function, however. After appropriate programming, the FPGA may then be said to be “configured to” perform the particular function.

For purposes of United States patent applications based on this disclosure, reciting in a claim that a structure is “configured to” perform one or more tasks is expressly intended not to invoke 35 U.S.C. § 112(f) for that claim element. Should Applicant wish to invoke Section 112(f) during prosecution of a United States patent application based on this disclosure, it will recite claim elements using the “means for” [performing a function] construct.

What is claimed is:

1. A non-transitory computer readable medium having program instructions stored therein that are executable by a computing system to perform operations, comprising:
generating an explainable artificial intelligence (XAI) model, wherein the XAI model provides a reason corresponding to an output of a first machine learning (ML) model; and
wherein the XAI model selects the reason from a set of reasons based on an aggregation function;
wherein the aggregation function combines a set of importance scores for a corresponding set of features mapped to the reason; and
determining one or more parameters of the aggregation function to improve an accuracy of the XAI model, wherein the one or more parameters are operable to adjust the output of the aggregation function.

2. The computer readable medium of claim 1, wherein the aggregation function determines a reason score for a given reason within the set of reasons by combining relevant importance scores mapped to the given reason, wherein the one or more parameters include a parameter that defines a number of combined relevant importance scores to determine the reason score for the given reason.

3. The computer readable medium of claim 1, wherein the aggregation function determines a reason score for a given reason within the set of reasons by combining relevant importance scores mapped to the given reason, wherein the one or more parameters include a parameter that identifies a manner in which the relevant importance scores are to be combined.

4. The computer readable medium of claim 1, wherein determining the one or more parameters includes:
calculating a cost function for the one or more parameters, wherein the cost function assesses false positive rates for reasons identified using the one or more parameters.

5. The computer readable medium of claim 1, wherein the operations further comprise:
receiving the output of the first ML model, wherein the output recommends a first action; and
determining whether to perform the first action based on the selected reason.

6. The computer readable medium of claim 5, wherein the determining includes:
identifying a conflict between the selected reason and the recommended first action; and
determining, based on the identified conflict, to not perform the first action.

7. The computer readable medium of claim 1, wherein the operations further comprise:
training an imitation model based on inputs and outputs of the first ML model, wherein the imitation model is trained to imitate the first ML model, wherein the imitation model is computationally less expensive than the first ML model, wherein the XAI model selects the reason based on an imitation output of the imitation model.

8. A method, comprising:
receiving, by a computing system, a request for a reason corresponding to an output of a first machine learning (ML) model;
determining, by the computing system and via a scoring algorithm, importance scores for a set of features input into the first ML model, wherein a given one of the importance scores is indicative of a given feature's impact on the received output; and
selecting, by the computing system, the reason from a set of reasons based on an aggregation function applied to the importance scores, wherein the aggregation function combines the importance scores based on one or more parameters determined to improve an accuracy of the selected reason.

9. The method of claim 8, wherein the scoring algorithm is a Shapley Additive Explanations (SHAP) algorithm, wherein the SHAP algorithm outputs the set of importance scores for the corresponding set of features, and wherein the one or more parameters includes a parameter that causes the aggregation function to select a subset of the importance scores.

10. The method of claim 8, wherein the aggregation function determines a reason score for a given reason within the set of reasons by combining relevant importance scores mapped to the given reason, wherein the one or more parameters include a parameter that defines a number of combined relevant importance scores.

11. The method of claim 8, further comprising:
receiving, the output of the first ML model, wherein the output recommends a first action; and
determining whether to perform the first action based on the selected reason.

12. The method of claim 11, wherein the determining includes:
identifying a conflict between the selected reason and the recommended first action; and
determining, based on the identified conflict, to not perform the first action.

13. The method of claim 11, wherein determining the one or more parameters includes calculating a cost function, wherein the cost function defines a risk associated with correctly determining whether to perform the first action based on the selected reason.

14. The method of claim 13, wherein the cost function is based on a false positive rate (FPR), wherein the FPR defines a rate of incorrectly determining whether to perform the action based on the selected reason.

15. A computing system, comprising:
one or more processors;
memory having program instructions stored therein that are executable by the one or more processors to cause the computing system to perform operations comprising:
generating an explainable artificial intelligence (XAI) model for a machine learning (ML) model, wherein the generating includes determining one or more parameters that adjust an output of an aggregation function;
receiving an output of the ML model based on a set of input features; and
providing, via the XAI model and based on the received output, a reason selected using the aggregation function and the determined one or more parameters to combine a set of importance scores corresponding to the set of input features.

16. The computing system of claim 15, wherein the operations further comprise:
applying a Shapley Additive Explanations (SHAP) algorithm to the set of input features to determine the set of importance scores, wherein the one or more parameters includes a parameter that causes the aggregation function to select a subset of the importance scores.

17. The computing system of claim 15, wherein the aggregation function determines a reason score for a given reason within a set of reasons by combining relevant importance scores mapped to the given reason, wherein the one or more parameters include a parameter that defines a number of combined relevant importance scores.

18. The computing system of claim 15, wherein the operations further comprise:
receiving, the output of the ML model, wherein the output is indicative of a first action; and
determining whether to perform the first action based on the provided reason.

19. The computing system of claim 18, wherein the determining includes:
identifying a conflict between the provided reason and the first action; and
determining, based on the identified conflict, to not perform the first action.

20. The computing system of claim 18, wherein determining the one or more parameters includes calculating a cost function, wherein the cost function defines a risk associated with correctly determining whether to perform the first action based on the provided reason.
